(19) United States
(12) Patent Application Publication
(10) Pub. No.: US 2025/0006050 A1
(43) Pub. Date: Jan. 2, 2025

(54) VEHICLE VIOLATION DETECTION METHOD, APPARATUS AND SYSTEM, AND STORAGE MEDIUM

(71) Applicant: BOE Technology Group Co., Ltd., Beijing (CN)

(72) Inventors: Jingtao XU, Beijing (CN); Mingxuan CHEN, Beijing (CN)

(21) Appl. No.: 18/705,561

(22) PCT Filed: Aug. 8, 2023
(86) PCT No.: PCT/CN2023/111730

§ 371 Date: Apr. 28, 2024

(30) Foreign Application Priority Data
Aug. 30, 2022 (CN) 202211056040.9

(51) Int. Cl. G08G 1/017; G06V 10/82; G06V 20/52; G06V 20/62; G08G 1/054

(52) U.S. Cl. CPC G08G 1/0175; G06V 10/82; G06V 20/52; G06V 20/625; G08G 1/054; G06V 2201/08

(57) ABSTRACT

A vehicle violation detection method, apparatus and system, and a storage medium. The vehicle violation detection method comprises: acquiring a plurality of frames of images, performing vehicle detection and tracking according to the plurality of frames of images, and generating vehicle information of a detected vehicle, the vehicle information comprising a vehicle detection box and vehicle model information, and the vehicle model information corresponding to the physical size of the vehicle; according to the size of the vehicle detection box of the vehicle and the physical size of the vehicle that corresponds to the vehicle model information of the vehicle, determining a correspondence between image coordinates in the images and absolute space coordinates, and according to the correspondence, determining speed information of the vehicle; and making a violation determination of the vehicle according to the speed information of the vehicle.

### CROSS-REFERENCE TO RELATED APPLICATIONS

The present application is a U.S. National Phase Entry of International Application No. PCT/CN2023/111730 having an international filing date of Aug. 8, 2023, which claims the priority of Chinese patent application No. 202211056040.9, filed to the CNIPA on Aug. 30, 2022. The above-identified applications are incorporated herein by reference in their entireties.

### TECHNICAL FIELD

The disclosure relates to a vehicle violation detection technology, in particular to a vehicle violation detection method, a device, a system and a storage medium.

### BACKGROUND

In recent years, with the rapid development of roads and vehicles, traffic problems such as vehicle violations have become increasingly prominent. Effective monitoring of violation vehicles is an important demand of road traffic management.

### SUMMARY

The following is a summary of subject matters described herein in detail. This summary is not intended to limit the protection scope of claims.

An embodiment of the present disclosure provides a vehicle violation detection method, including:
acquiring multiple frames of images, carrying out vehicle detection and tracking according to the multiple frames of images, and generating vehicle information of a detected vehicle, wherein the vehicle information includes a vehicle detection box and vehicle model information; the vehicle type information corresponds to a vehicle physical size;
determining a correspondence relationship between image coordinates in the images and absolute spatial coordinates according to a size of a vehicle detection box of the vehicle and a vehicle physical size corresponding to vehicle model information of the vehicle, and determining speed information of the vehicle according to the correspondence relationship; and
carrying out violation determination of the vehicle according to the speed information of the vehicle.

In an exemplary embodiment, acquiring the multiple frames of images, and carrying out vehicle detection and tracking according to the multiple frames of images includes:
acquiring one frame of image, when a vehicle is detected in the frame of image, tracking the vehicle in at least one subsequent frame of image, recording vehicle detection boxes of successive S frames of images of the vehicle, and when a ratio of an overlapping area of vehicle detection boxes of the vehicle in adjacent frames of images of the S frames of image to an area of any vehicle detection box of the vehicle in the adjacent frames of images is greater than or equal to a preset ratio threshold, identifying vehicle model information of the vehicle, wherein, 0< the preset ratio threshold<1, and S is an integer greater than 1.

In an exemplary embodiment, 0.35≤ preset ratio threshold≤0.75.

In an exemplary embodiment, determining the speed information of the vehicle according to the correspondence relationship includes:
determining absolute spatial coordinates corresponding to same positions in the vehicle detection boxes of two frames of images according to the correspondence relationship, determining a displacement distance between the same positions in the vehicle detection boxes of the two frames of images according to the absolute spatial coordinates corresponding to the same positions in the vehicle detection boxes of the two frames of images, and determining a first speed of the vehicle according to the displacement distance and a time interval between the two frames of images;
taking the first speed as the speed information of the vehicle; or, acquiring multiple first speeds according to images of different frames, and taking an average value of the multiple first speeds as the speed information of the vehicle.

In an exemplary embodiment, the two frames of images are two adjacent frames of images;
the acquiring the multiple first speeds according to images of different frames includes:
acquiring the multiple first speeds according to images of every two adjacent frames in successive multiple frames of images.

In an exemplary embodiment, carrying out the violation determination of the vehicle according to the speed information of the vehicle includes at least one of the following:
determining illegal parking of the vehicle when the speed information of the vehicle is zero, the vehicle is located in an illegal parking lane, and a time for the vehicle to stay in the illegal parking lane is greater than a preset first alarm time threshold;
determining vehicle accident when the speed information of the vehicle is zero, the vehicle is located in a non-illegal parking lane, a time for the vehicle to stay in the non-illegal parking lane is longer than a preset third alarm time threshold, and a pedestrian or a preset warning sign is detected in a preset periphery range of the vehicle detection box;
determining illegal parking of the vehicle when the speed information of the vehicle is zero, the vehicle is located in a non-illegal parking lane, a time for the vehicle to stay in the non-illegal parking lane is longer than the preset third alarm time threshold, and a pedestrian or a preset warning sign is not detected in a preset periphery range of the vehicle detection box;
determining illegal wrong way of the vehicle when the speed information of the vehicle is non-zero, a driving direction of the vehicle is inconsistent with a driving direction of a lane where the vehicle is located, and a time for the vehicle to drive on to drive on wrong way is longer than a preset second alarm time threshold;
determining illegal low-speed of the vehicle when the speed information of the vehicle is less than a preset low-speed threshold, a driving direction of the vehicle is consistent with a driving direction of a lane where the vehicle is located, and a time for the speed information of the vehicle less than the preset low-speed threshold is longer than the preset fourth alarm time; and
determining illegal speeding of the vehicle when the speed information of the vehicle is greater than a preset speeding threshold, a driving direction of the vehicle is consistent with a driving direction of a lane where the vehicle is located, and a time for the speed information of the vehicle greater than the preset speeding threshold is greater than a preset fifth alarm time.

In an exemplary embodiment, the vehicle information further includes: license plate information; the method further includes: determining a terminal equipment associated with the vehicle according to the license plate information; and,
after the violation determination of the vehicle is carried out according to the speed information of the vehicle and that the vehicle has violation is determined, sending violation behavior information of the vehicle to the terminal equipment associated with the vehicle.

In an exemplary embodiment, the method further includes: storing vehicle information, and violation behavior information generated after the violation determination of the vehicle is carried out, performing statistics based on the vehicle information and the violation behavior information to generate statistical information, and sending statistical information related to the vehicle to the terminal equipment associated with the vehicle, wherein the statistical information related to the vehicle includes at least one of the following: statistical information obtained by performing statistics based on the violation behavior information of the vehicle and statistical information obtained by performing statistics based on the violation behavior information of the vehicle model to which the vehicle belongs.

In an exemplary embodiment, the violation behavior information includes a road section where a violation behavior occurred, and the statistical information includes at least one of the following: frequencies of different violation behaviors of a same vehicle, frequencies of different violation behaviors of a same vehicle model, and frequencies of violation behaviors of a same vehicle model on different road sections.

An embodiment of the disclosure provides a vehicle violation detection device, including a processor and a memory storing a computer program runnable on the processor, wherein the processor executes the program to implement the acts of the vehicle violation detection method described in any of the above embodiments.

An embodiment of the disclosure provides a computer-readable storage medium which stores program instructions. When the program instructions are executed, the vehicle violation detection method described in any of the above embodiments may be achieved.

An embodiment of the present disclosure provides a vehicle violation detection system, including: a video acquiring device, and the vehicle violation detection device described above, wherein the video acquiring device is configured to acquire an image of a preset monitoring region and send the image to the vehicle violation detection device.

An embodiment of the disclosure provides a vehicle violation detection device including: a vehicle information identification module and a violation behavior detection module.

The vehicle information identification module is configured to acquire multiple frames of images, carry out vehicle detection and tracking according to the multiple frames of images, and generate vehicle information of a detected vehicle, wherein the vehicle information includes a vehicle detection box and vehicle model information, and the vehicle model information corresponds to a vehicle physical size; and output the vehicle information to the violation behavior detection module.

The violation behavior detection module is configured to determine a correspondence relationship between image coordinates in the images and absolute spatial coordinates according to a size of a vehicle detection box of the vehicle and a vehicle physical size corresponding to the vehicle model information of the vehicle, and determine speed information of the vehicle according to the correspondence relationship; and carry out violation determination of the vehicle according to the speed information of the vehicle.

In an exemplary embodiment, the vehicle violation detection device further includes a data storage module and a data analysis module.

The vehicle information identification module is further configured to send the vehicle information to the data storage module, wherein the vehicle information further includes license plate information.

The violation behavior detection module is further configured to generate violation behavior information after the violation determination of the vehicle is carried out according to the speed information of the vehicle, send the violation behavior information to the data storage module, determine a terminal equipment associated with the vehicle according to the license plate information of the vehicle, and send the violation behavior information of the vehicle to the terminal equipment associated with the vehicle.

The data storage module is configured to store the vehicle information sent by the vehicle information identification module and store the violation behavior information sent by the violation behavior detection module.

The data analysis module is configured to perform statistics and generate statistical information according to the vehicle information and the violation behavior information stored in the data storage module, and send the statistical information related to the vehicle to a terminal equipment associated with the vehicle, wherein the statistical information related to the vehicle including at least one of the following: statistical information obtained by performing statistics according to the violation behavior information of the vehicle, and statistical information obtained by performing statistics according to the violation behavior information of the vehicle model to which the vehicle belongs.

Other aspects of the present disclosure may be comprehended after the drawings and the detailed descriptions are read and understood.

### BRIEF DESCRIPTION OF DRAWINGS

Accompanying drawings are used to provide further understanding of technical schemes of the present disclosure, constitute a part of the specification, and are used to explain the technical schemes of the present disclosure together with the embodiments of the present disclosure but not to form limitations on the technical schemes of the present disclosure.

FIG. 1 is a block diagram of a vehicle violation detection system according to an exemplary implementation.

FIG. 2 is a flowchart of a vehicle violation detection method according to an exemplary embodiment.

FIG. 3 is a flowchart of a vehicle detection, tracking and identification method according to an exemplary embodiment.

FIG. 4 is a flowchart of a vehicle violation detection method according to an exemplary embodiment.

FIG. 5 is a block diagram of a vehicle violation detection device according to an exemplary embodiment.

FIG. 6 is a block diagram of a computer readable storage medium according to an exemplary embodiment.

### DETAILED DESCRIPTION

Multiple embodiments are described in the present disclosure. However, the description is exemplary and unrestrictive. Moreover, it is apparent to those of ordinary skills in the art that there may be more embodiments and implementation schemes in the scope of the embodiments described in the present disclosure. Although many possible combinations of features are shown in the accompanying drawings and discussed in specific implementations, many other combinations of the disclosed features are also possible. Unless expressly limited, any feature or element of any embodiment may be used in combination with, or may replace, any other feature or element in any other embodiment.

The present disclosure includes and conceives combinations with the features and elements known to those of ordinary skills in the art. The embodiments, features, and elements that have been disclosed in the present disclosure may also be combined with any conventional feature or element to form unique inventive schemes defined by the claims. Any feature or element of any embodiment may also be combined with a feature or an element from another inventive scheme to form another unique inventive scheme defined by the claims. Therefore, it should be understood that any of the features shown and/or discussed in the present disclosure may be implemented alone or in any suitable combination. Therefore, the embodiments are not to be limited except the limitations by the appended claims and equivalents thereof. Furthermore, various modifications and variations may be made within the protection scope of the appended claims.

Moreover, when describing representative embodiments, the specification may have presented a method and/or a process as a particular sequence of acts. However, to an extent that the method or the process does not depend on the specific sequence of the acts described herein, the method or the process should not be limited to the acts with the specific sequence. Those of ordinary skills in the art will understand that other sequences of acts may also be possible. Therefore, the specific sequence of the acts illustrated in the specification should not be interpreted as a limitation on claims. Moreover, claims directed to the method and/or process should not be limited to performing their acts in a described sequence, and those skilled in the art may readily understand that these sequences may be varied and still remain within the essence and scope of the embodiments of the present disclosure.

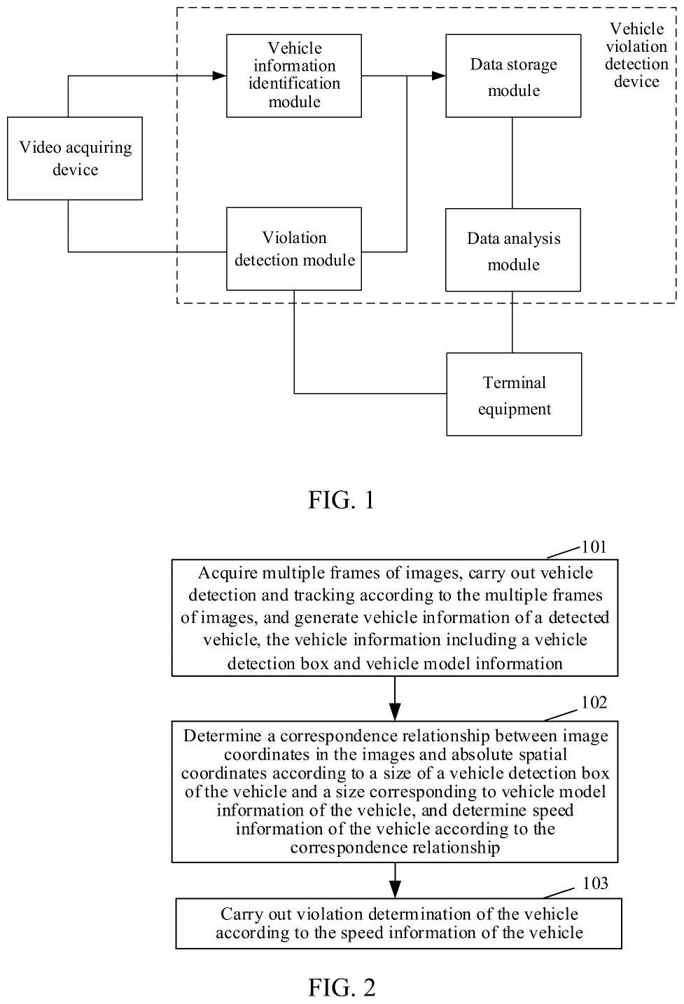

FIG. 1 is a schematic diagram of a vehicle violation detection system according to an exemplary embodiment. As shown in FIG. 1, the vehicle violation detection system provided by the embodiment of the present disclosure may include a video acquiring device, a vehicle violation detection device, and a terminal equipment. The video acquiring device may be connected to the vehicle violation detection device in a wired or wireless mode. The vehicle violation detection device may be, for example, a cloud device. The terminal equipment may be wirelessly connected to the vehicle violation detection device.

The video acquiring device is configured to acquire an image of a preset monitoring region and send the image to the vehicle violation detection device. The image may include a video image. The video acquiring device may acquire images of the preset monitoring region in real time.

The vehicle violation detection device is configured to carry out vehicle detection and tracking according to the image sent by the video acquiring device, generate vehicle information, perform vehicle violation determination according to the vehicle information, generate violation behavior information, store the vehicle information and the violation behavior information, perform statistical analysis according to the vehicle information and the violation behavior information and generate statistical information, determine a terminal equipment associated with the vehicle according to the vehicle information, and send the violation behavior information of the vehicle and the statistical information related to the vehicle to the terminal equipment associated with the vehicle. The statistical information related to the vehicle includes at least one of the following: statistical information obtained by performing statistics according to the violation behavior information of the vehicle, and statistical information obtained by performing statistics according to violation behavior information of a vehicle model to which the vehicle belongs.

The terminal equipment is configured to receive the violation behavior information and the statistical information. The terminal equipment may display the violation behavior information and the statistical information to the vehicle owner, so as to remind the vehicle owner and reduce occurrence of violation behaviors.

In an exemplary embodiment, the video acquiring device may be a road monitoring device. The existing road monitoring devices may be used, so as to reduce the cost. However, embodiments of the present disclosure are not limited thereto, and the video acquiring device may be a redeployed monitoring device.

In an exemplary embodiment, the vehicle violation detection device may send the violation behavior information and statistical information in a push way. However, embodiments of the present disclosure are not limited thereto, and the violation behavior information and statistical information may be sent in other ways.

In an exemplary embodiment, the terminal equipment may be a mobile intelligent terminal or a vehicle-mounted terminal. The terminal equipment associated with the vehicle may be a mobile intelligent terminal of the owner of the vehicle or a vehicle-mounted terminal installed on the vehicle. The mobile intelligent terminal or vehicle-mounted terminal may communicate with the vehicle violation detection device through an application program (APP) or other means.

In an exemplary embodiment, as shown in FIG. 1, the vehicle violation detection device may include a vehicle information identification module and a violation behavior detection module.

The vehicle information identification module is configured to acquire multiple frames of images, carry out vehicle detection and tracking according to the multiple frames of images, and generate vehicle information of a detected vehicle, wherein the vehicle information may include a vehicle detection box and vehicle model information; the vehicle model information corresponds to a vehicle physical size; and output the vehicle information to the violation behavior detection module. The vehicle information identification module may obtain images from a video acquiring device.

The violation behavior detection module is configured to determine a correspondence relationship between image coordinates in the image and absolute spatial coordinates according to a size of a vehicle detection box of the vehicle and a vehicle physical size corresponding to vehicle model information of the vehicle, and determine speed information of the vehicle according to the correspondence relationship; and carry out violation determination of the vehicle according to the speed information of the vehicle.

According to the scheme provided by the embodiment, the speed information of the vehicle may be determined according to the images without a speed measurement sensor, and thus the vehicle violation determination is carried out, with low cost and simple implementation.

In an exemplary embodiment, the license plate information may include a license plate number.

In an exemplary embodiment, the vehicle information identification module may use vehicle detection training data for pre-training to obtain a vehicle detection neural network model, and carry out vehicle detection according to the vehicle detection neural network model, wherein coordinates of the vehicle detection box may be marked in the vehicle detection training data; and the vehicle detection neural network model may be, for example, a yolov5 neural network model and the like. When the vehicle information identification module detects a vehicle, it may output an image including a vehicle detection box, or output position information of the vehicle detection box in the image.

In an exemplary implementation, the vehicle detection box may be a smallest rectangular box including the vehicle. However, embodiments of the present disclosure are not limited thereto, and the vehicle detection box may be of other shapes.

In an exemplary implementation, the vehicle information identification module may be pre-trained to obtain a license plate identification neural network model, and license plate identification is performed according to the license plate identification neural network model. However, embodiments of the present disclosure are not limited thereto, and license plate identification may be performed in other ways.

In an exemplary implementation, the vehicle information identification module may be pre-trained to obtain a vehicle model identification neural network model, and vehicle model identification is performed according to the vehicle model identification neural network model. However, the embodiments of the present disclosure are not limited thereto, and vehicle model identification may be performed in other ways. The vehicle model identification neural network model may be updated in a process of vehicle violation detection.

In an exemplary embodiment, vehicle model identification and vehicle detection may use a same neural network model, an image is input to the neural network model, and a vehicle detection box and vehicle model information are output. However, embodiments of the present disclosure are not limited thereto, and different neural network models may be used for vehicle detection and vehicle model identification respectively. The vehicle information identification module may use the vehicle detection training data for pre-training to obtain a vehicle detection neural network model, and vehicle detection is carried out according to the vehicle detection neural network model, wherein coordinates of the vehicle detection box and the vehicle model of the vehicle may be marked in the vehicle detection training data. After the images are input to the trained vehicle detection neural network model later, the coordinates of the vehicle detection box and the vehicle model of the vehicle may be output.

In an exemplary embodiment, the violation determination includes, but is not limited to, at least one of: determinations of illegal speeding, illegal low-speed, illegal wrong way, and illegal parking. The illegal wrong way may include illegal reversing, and a behavior of driving in an opposite direction to a prescribed direction of a lane.

In an exemplary embodiment, the violation behavior detection module may also be configured to determine a driving track of the vehicle based on images. According to the images, positions of the vehicle may be determined, and a driving trajectory of the vehicle may be determined according to the positions. The position of the vehicle may be represented by a position of a center point of a vehicle detection box of the vehicle.

In an exemplary embodiment, the vehicle violation detection device may further include a data storage module and a data analysis module.

The vehicle information identification module is further configured to send the vehicle information to the data storage module, wherein the vehicle information may further include license plate information.

The violation behavior detection module is further configured to generate violation behavior information after the violation determination of the vehicle is carried out according to the speed information of the vehicle, send the violation behavior information to the data storage module, determine a terminal equipment associated with the vehicle according to the license plate information of the vehicle, and send the violation behavior information of the vehicle to the terminal equipment associated with the vehicle.

The data storage module is configured to store the vehicle information sent by the vehicle information identification module and store the violation behavior information sent by the violation behavior detection module.

The data analysis module is configured to perform statistics according to the vehicle information and the violation behavior information stored in the data storage module and generate statistical information, and send statistical information related to the vehicle to the terminal equipment associated with the vehicle, wherein the statistical information related to the vehicle includes at least one of the following: statistical information obtained by performing statistics according to the violation behavior information of the vehicle and statistical information obtained by performing statistics according to the violation behavior information of the vehicle model to which the vehicle belongs.

In an exemplary embodiment, the vehicle model information may include, but is not limited to, small family cars, trucks, commercial vehicles, buses, and the like.

Taking a vertex of a lower left corner or center point of a vehicle detection box in an image as an example, the method for converting a pixel coordinate position to a position in the world coordinate system (i.e., absolute spatial coordinates) is explained.

From image coordinate points to actual coordinate points, a pixel coordinate system may be converted to an image coordinate system, then be converted to a camera coordinate system, and then be converted from camera coordinate system to the world coordinate system. The world coordinate system is an absolute coordinate system of the objective three-dimensional world. The camera coordinate system is a coordinate system established by taking a camera light spot as a center, X and Y axes parallel to two sides of an image, and an optical axis as the Z axis. The image coordinate system takes an image center as a coordinate origin, and the X and Y axes are parallel to two sides of the image. The pixel coordinate system is a coordinate system by taking an upper left corner of an image as the origin, and the X and Y axes parallel to two sides of the image respectively.

(1) Assumed coordinates of a position, where there is a vehicle P, in the world coordinate system are (X, Y, Z); (Xc, Yc, Zc) is used to denote position coordinates of the vehicle P in the camera coordinate system; (x, y) is used to denote coordinate values of the vehicle P in the image coordinate system; and (u, v) is used to denote coordinate values of the vehicle P in the pixel coordinate values.

(2) There is a rigid conversion relationship between the world coordinate system and the camera coordinate system. Because they are both three-dimensional coordinate systems, and their coordinate positions are different, a certain point in the world coordinate system may be converted into a coordinate point in the camera coordinate system by a rotation matrix R and translation matrix t, and the formula is as follows:

$$[ \begin{matrix}X c \\ {Y}_{C} \\ Z c \\ 1\end{matrix} ] = [ \begin{matrix}R & t \\ {0}^{T} & 1\end{matrix} ] [ \begin{matrix}X \\ Y \\ Z \\ 1\end{matrix} ] \qquad ( 1 )$$

Where R is a matrix of 3×3, t is a matrix of 3×1, the rotation matrix R and the translation matrix t may be determined by a height h from the ground and an attitude angle R0 (Ø, θ, φ) of the camera:

$$R = [ \begin{matrix}cos θ cos ∅ & sin φ sin θ cos ∅ - cos φ sin ∅ & cos φ sin θ cos ∅ + sin ϕ sin ∅ \\ cos θ sin ∅ & sin φ sin θ sin ∅ + cos φ cos ∅ & cos φ sin θ sin ∅ - sin ϕ cos ∅ \\ - s in θ & sin φ cos θ & cos φ cos θ\end{matrix} ]$$

$$t = ( 0 , 0 , h )$$

(3) There is a perspective projection conversion relationship between the camera coordinate system and the image coordinate system, and the formula is as follows, where f is the known focal length of the camera:

$$\frac{x}{f} = \frac{Xc}{Zc}$$

$$\frac{y}{f} = \frac{Yc}{Zc}$$

Those are converted to a homogeneous coordinate system and matrixes, denoted as:

$$Z c [ \begin{matrix}x \\ y \\ 1\end{matrix} ] = [ \begin{matrix}f & 0 & 0 & 0 \\ 0 & f & 0 & 0 \\ 0 & 0 & 1 & 0\end{matrix} ] [ \begin{matrix}X c \\ {Y}_{C} \\ Z c \\ 1\end{matrix} ] \qquad ( 2 )$$

(4) There is an affine conversion relationship between the image coordinate system and the pixel coordinate system, that is, the unit of (x, y) in the image coordinate system is mm, where dx represents a physical distance of each pixel, dx may be determined according to a size of a vehicle detection box and a vehicle physical size corresponding to vehicle model information of a vehicle, and the unit of dx is mm/pix, so the unit of x×(1/dx) is pix (pixel). So the relationship formula is as follows, where (u₀, V₀) represents coordinates of an origin in the image coordinate system in the pixel coordinate system.

$$u = \frac{x}{d x} + {u}_{0}$$

$$v = \frac{y}{d y} + {v}_{0}$$

Those are converted to a matrix form as:

$$[ \begin{matrix}u \\ v \\ 1\end{matrix} ] = [ \begin{matrix}\frac{1}{d x} & 0 & {u}_{0} \\ 0 & \frac{I}{d y} & {v}_{0} \\ 0 & 0 & 1\end{matrix} ] [ \begin{matrix}x \\ y \\ 1\end{matrix} ] \qquad ( 3 )$$

To sum up, the position coordinates of a vehicle P in the world coordinate system are (X, Y, Z), and the pixel position coordinates of the vehicle in the image are (u, v), by the rigid conversion matrix

$$[ \begin{matrix}R & t \\ 0 & 1\end{matrix} ] ,$$

perspective projection conversion matrix

$$[ \begin{matrix}f & 0 & 0 & 0 \\ 0 & f & 0 & 0 \\ 0 & 0 & 1 & 0\end{matrix} ] ,$$

and affine conversion matrix

$$[ \begin{matrix}\frac{1}{d x} & 0 & {u}_{0} \\ 0 & \frac{1}{d y} & {v}_{0} \\ 0 & 0 & 1\end{matrix} ]$$

there is the following relationship:

$$Z c [ \begin{matrix}u \\ v \\ 1\end{matrix} ] = [ \begin{matrix}\frac{1}{d x} & 0 & {u}_{0} \\ 0 & \frac{1}{d y} & {v}_{0} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R & t \\ 0 & 1\end{matrix} ] [ \begin{matrix}X \\ Y \\ Z \\ 1\end{matrix} ] \qquad ( 4 )$$

From the above formula, it can be seen that from (X, Y, Z) in the world coordinate system to (u, v) in the pixel coordinate system, there is actually a change in a position variable Zc, and the formula of Zc is as follows:

$$Z c = \frac{fh cos φ cos θ}{x cos ∅} \qquad ( 5 )$$

The rigid conversion matrix may be determined by external parameters of the camera, that is, the height h from the ground and the attitude angle R0 (Ø, θ, φ) of the camera. The perspective projection conversion matrix and affine conversion matrix belong to internal parameters and may be obtained by calibration. Therefore, given the vehicle coordinate position (u, v) in the image, x may be obtained according to Formula (3); then Zc is obtained according to Formula (5); and then, according to Formula (4), the position coordinates of vehicle in the actual scene are obtained as (X, Y, Z).

In an exemplary embodiment, determining, by the violation behavior detection module, the speed information of the vehicle according to the correspondence relationship may include: determining absolute spatial coordinates corresponding to same positions in vehicle detection boxes of two frames of images according to the correspondence relationship, determining a displacement distance between the same positions in the vehicle detection boxes of the two frames of images according to the absolute spatial coordinates corresponding to the same positions in the vehicle detection boxes of the two frames of images, and determining a first speed of the vehicle according to the displacement distance and a time interval between the two frames of images; taking the first speed as the speed information of the vehicle; or, acquiring multiple first speeds according to images of different frames, and taking an average value of the multiple first speeds as the speed information of the vehicle.

In an exemplary embodiment, the vehicle information may further include an average driving speed of the vehicle, a maximum driving speed of the vehicle, a minimum driving speed of the vehicle, a vehicle trajectory, and the like.

In an exemplary embodiment, the data storage module may store the vehicle information and the violation behavior information into a database.

In an exemplary embodiment, the data analysis module may periodically perform statistics of violation behaviors at a preset period. For example, the frequencies of different violation behaviors of the same vehicle and the frequencies of different violation behaviors of the same vehicle model may be counted. The statistical period may be one day, one week, one month, one quarter or one year, etc. It is to count the most violation-prone behaviors of the same vehicle or the same vehicle model (for example, the most frequent violation behaviors or the most frequent and the second most frequent violation behaviors, etc. may be determined by sorting the violation behaviors according to the frequency), and the road sections most violation-prone (the violation behaviors of different road sections may be counted to determine the road sections with the most frequent violation behaviors, or the road sections with the most frequent and the road sections with the second most frequent violation behaviors, etc.).

FIG. 2 is a flowchart of a vehicle violation detection method according to an exemplary embodiment. As shown in FIG. 2, the vehicle violation detection method provided by this embodiment may include the following acts.

In act 201, multiple frames of images are acquired, vehicle detection and tracking are carried out according to the multiple frames of images, and vehicle information of a detected vehicle is generated, wherein the vehicle information includes a vehicle detection box and vehicle model information; and the vehicle model information corresponds to a vehicle physical size.

The vehicle model information corresponds to the vehicle physical size, i.e., the physical size of the vehicle model indicated by the vehicle model information, and an average length from the front to the rear of the vehicle of this vehicle model may be used as the physical size of this vehicle model.

In act 202, a correspondence relationship between image coordinates in the image and absolute spatial coordinates according to a size of a vehicle detection box of the vehicle and a vehicle physical size corresponding to vehicle model information of the vehicle, and speed information of the vehicle is determined according to the correspondence relationship.

In act 203, violation determination of the vehicle is carried out according to the speed information of the vehicle.

According to the scheme provided by the embodiment, the speed information of the vehicle may be determined according to images, the vehicle violation determination without a sensor can be achieved, the existing monitoring device may be reused, and the cost is low and the implementation is simple.

In an exemplary embodiment, the acquiring multiple frames of images, and carrying out vehicle detection and tracking according to the multiple frames of images includes: acquiring one frame of image; when a vehicle is detected in the frame of image, tracking the vehicle in at least one subsequent frame of image, recording vehicle detection boxes of successive S frames of images of the vehicle, and when a ratio of an overlapping area of vehicle detection boxes of the vehicle in adjacent frames of images of the S frames of images to an area of any vehicle detection box of the vehicle in the adjacent frames of images is greater than or equal to a preset ratio threshold, identifying the vehicle model information of the vehicle, wherein, 0< the preset ratio threshold<1, and S is an integer greater than 1.

In an exemplary embodiment, adjacent frames of images in the S frames of images are every two adjacent frames of images in the S frames of images.

Taking S being 5 and the first to fifth successive frames as an example, a vehicle A is detected. When a ratio of an overlapping area of vehicle detection boxes of the vehicle A in the first frame and the second frame to an area of the vehicle detection box of the vehicle A in the first frame or the second frame is greater than or equal to a preset ratio threshold, a ratio of an overlapping area of vehicle detection boxes of the vehicle A in the second frame and the third frame to an area of the vehicle detection box of the vehicle A in the second frame or the third frame is greater than or equal to the preset ratio threshold, a ratio of an overlapping area of vehicle detection boxes of the vehicle A in the third frame and the fourth frame to an area of the vehicle detection box of the vehicle A in the third frame or the fourth frame is greater than or equal to the preset ratio threshold, and a ratio of an overlapping area of vehicle detection boxes of the vehicle A in the fourth frame and the fifth frame to an area of the vehicle detection box of the vehicle A in the fourth frame or the fifth frame is greater than or equal to the preset ratio threshold, the model information of vehicle A is identified. When there are any two adjacent frames in the first frame to the fifth frame, and a ratio of an overlapping area of vehicle detection boxed of the vehicle A in the two adjacent frames to an area of the vehicle detection box of the vehicle A in any one of the two adjacent frames is less than the preset ratio threshold, the vehicle model information of the vehicle A is not identified, that is, the vehicle A is not identified. The present implementation is not limited to this, it may be that part of the adjacent frames of images in the S frames of images satisfies that a ratio of areas is greater than or equal to the preset ratio threshold. The scheme provided by the embodiment can reduce the probability of identifying overlapping vehicles as one vehicle. Overlapping vehicles usually do not maintain the same speed, so the images of overlapping vehicles are different in different frames, and the overlapping area is small, so overlapping vehicles may be eliminated.

In an exemplary embodiment, the preset ratio threshold may satisfy: 0.35≤ the preset ratio threshold≤0.75. When the preset ratio threshold is within this value range, the detection error can be reduced.

In an exemplary embodiment, the determining the speed information of the vehicle according to the correspondence relationship includes: determining absolute spatial coordinates corresponding to the same positions of the vehicle detection boxes of the two frames of images according to the correspondence relationship, determining a displacement distance between the same positions of the vehicle detection boxes of the two frames of images according to the absolute spatial coordinates corresponding to the same positions of the vehicle detection boxes of the two frames of images, and determining a first speed of the vehicle according to the displacement distance and a time interval between the two frames of images; wherein the same position is, for example, a center point of a vehicle detection box; however, embodiments of the present disclosure are not limited thereto and may be in other positions; taking the first speed as speed information of the vehicle; or, acquiring multiple first speeds according to images of different frames, and taking an average value of the multiple first speeds as speed information of the vehicle.

In an exemplary embodiment, the two frames of images may be adjacent two frames of images.

The acquiring multiple first speeds according to images of different frames may include: acquiring multiple first speeds according to images of every two adjacent frames in successive multiple frames of images.

In this embodiment, the first speed is determined by two adjacent frames of images, but the embodiments of the present disclosure are not limited thereto, and the first speed may be determined by images of non-adjacent frames. For example, the first speed is determined by two frames of images spaced from each other by one frame of image, and so on. In the embodiment, multiple first speeds are acquired according to images of every two adjacent frames in successive multiple frames of images, which can better reflect the real-time speed of the vehicle and reduce errors.

In an exemplary embodiment, the carrying out the violation determination of the vehicle according to the speed information of the vehicle includes at least one of the following:
determining illegal parking of the vehicle when the speed information of the vehicle is zero, the vehicle is located in an illegal parking lane, and a time for the vehicle to stay in the illegal parking lane is greater than a preset first alarm time threshold; wherein the preset first alarm time threshold is greater than 0;
determining vehicle accident when the speed information of the vehicle is zero, the vehicle is located in a non-illegal parking lane, a time for the vehicle to stay in the non-illegal parking lane is longer than a preset third alarm time threshold, and a pedestrian or a preset warning sign is detected in a preset periphery range of the vehicle detection box; the preset third alarm time threshold is greater than 0;
determining illegal parking of the vehicle when the speed information of the vehicle is zero, the vehicle is located in a non-illegal parking lane, a time for the vehicle to stay in the non-illegal parking lane is longer than the preset third alarm time threshold, and a pedestrian or a preset warning sign is not detected in the preset periphery range of the vehicle detection box;
determining illegal wrong way of the vehicle when the speed information of the vehicle is non-zero, a driving direction of the vehicle is inconsistent with a driving direction of a lane where the vehicle is located, and a time for the vehicle to drive on wrong way is longer than a preset second alarm time threshold; wherein the illegal wrong way may include a case of illegal reversing; and the preset second alarm time threshold is greater than 0;
determining illegal low-speed of the vehicle when the speed information of the vehicle is less than a preset low-speed threshold, a driving direction of the vehicle is consistent with a driving direction of a lane where the vehicle is located, and a time for the speed information of the vehicle less than the preset low-speed threshold is longer than a preset fourth alarm time;
wherein the preset fourth alarm time threshold is greater than 0;
determining illegal speeding of the vehicle when the speed information of the vehicle is greater than a preset speeding threshold, a driving direction of the vehicle is consistent with a driving direction of a lane where the vehicle is located, and a time for the speed information of the vehicle greater than the preset speeding threshold is greater than a preset fifth alarm time; wherein the preset fifth alarm time threshold is greater than 0.

In an exemplary embodiment, before the violation determination of the vehicle is carried out based on the speed information of the vehicle, the method may further include: determining lane type information, lane speed threshold information, and lane driving direction. Lane information may include, for example, a fast lane, low-speed lane, emergency lane, etc.

In an exemplary embodiment, a preset periphery range may be a periphery range that is 1 to 3 times the vehicle detection box, that is, an area of the preset periphery range and an area of the vehicle detection box are 2 to 4 times the area of the vehicle detection box. This is an example only, which may be other ranges.

In an exemplary embodiment, the vehicle information may further include: license plate information.

The method may further include: determining a terminal equipment associated with the vehicle according to the license plate information; and, after the violation determination of the vehicle is carried out according to the speed information of the vehicle and it is determined that the vehicle has violation, sending violation behavior information of the vehicle to the terminal equipment associated with the vehicle.

The scheme provided by the embodiment may inform a vehicle owner of the violation behavior information in time, which is convenient for the vehicle owner to perceive the violation behavior in time and carry out a corresponding response operation.

In an exemplary embodiment, the method may further include: storing vehicle information, and violation behavior information generated after the violation determination of the vehicle is carried out, performing statistics based on the vehicle information and the violation behavior information and generating statistical information, and sending the statistical information related to the vehicle to a terminal equipment associated with the vehicle, wherein the statistical information related to the vehicle includes at least one of the following: statistical information obtained by performing statistics according to the violation behavior information of the vehicle, and statistical information obtained by performing statistics according to the violation behavior information of the vehicle model to which the vehicle belongs.

In an exemplary embodiment, the violation behavior information may include a road section where the violation behavior occurred, and the statistical information may include, but is not limited to, at least one of the following: frequencies of different violation behaviors of the same vehicle, frequencies of different violation behaviors of the same vehicle model, and frequencies of violation behaviors of the same vehicle model on different road sections. The road section where the violation behavior occurred may be determined according to a position where a video acquiring device sending the image is located. According to the frequencies of different violation behaviors of the same vehicle, the most violation-prone behavior of the same vehicle may be determined, and according to the frequencies of different violation behaviors of the same vehicle model, the most violation-prone behavior of the same vehicle model may be determined 1, and according to the frequencies of violation behaviors on different road sections of the same vehicle model, the road section where the vehicle model is most prone to violation behaviors may be determined. When statistical information is sent, only the most frequent violation behavior in the statistical information may be sent to the corresponding vehicle, the most frequent violation behavior of the vehicle model that vehicle belongs to may be sent to the vehicle, and the road section with the most frequent violation behavior of the vehicle model that the vehicle belongs to may be sent to the vehicle, so as to achieve an advance notice of possible violation behaviors and reduce the occurrence of violation behaviors.

Taking the vehicle A as an example, statistics may be carried out according to the violation behavior information of the vehicle A to obtain a frequency of violation behaviors of the vehicle A, and the statistics may be based on a preset period, which may, for example, be one or more of a day, a week, a month, a quarter or a year, etc. The most frequent violation behavior of the vehicle A and the corresponding occurrence frequency may be sent to the terminal equipment associated with the vehicle A, or the occurrence frequencies of part or all of the violation behaviors of the vehicle A may be sent to the terminal equipment associated with the vehicle A. Vehicle A belongs to vehicle model B, and statistics may be carried out according to the violation behavior information of vehicle model B to obtain the occurrence frequency of violation behaviors of the vehicle model B and the occurrence frequencies of violation behaviors of the vehicle model B on different road sections, and the occurrence frequencies of all or part of violation behaviors of the vehicle model B may be sent to vehicles belonging to the vehicle model B, for example, to vehicle A. The road section with the most frequent violation behavior of the vehicle model B may be sent to the vehicle belonging to the vehicle model B, and the road sections with the top N violation occurrence frequencies of the vehicle model B may be sent to the vehicles belonging to the vehicle model B, for example, the road sections with the top 3 violation occurrence frequencies of the vehicle model B may be sent to the vehicles belonging to the vehicle model B, and so on. According to the scheme provided by the embodiment, from the statistics and analysis of different violation behaviors of the same vehicle it can be inferred that the violation behaviors that are prone to occur by the driver of the vehicle, and an advance notice is provided to reduce the occurrence of violation behaviors. According to the statistics and analysis of different violation behaviors of different vehicle models, it can be inferred the most violation-prone behaviors and the road sections that are most prone to violation behaviors, and an advance notice is provided to reduce the occurrence of violation behaviors.

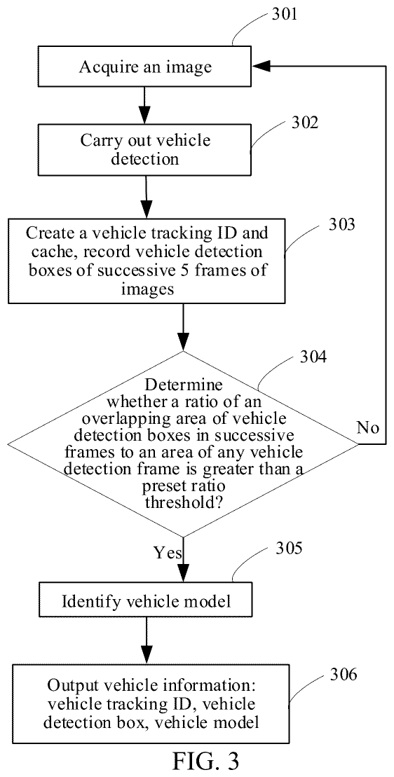

FIG. 3 is a flowchart of a vehicle detection, tracking and identification method according to an exemplary embodiment. As shown in FIG. 3, the method for vehicle detection, tracking and identification provided by the present embodiment may include the following acts.

In act 301, an image is acquired.

The image includes an image acquired by a video acquiring device.

In an exemplary embodiment, the video acquiring device may include, but is not limited to, a monitoring device of a road monitoring system.

In act 302, vehicle detection is carried out according to the image.

In an exemplary embodiment, a vehicle detection neural network model may be established in advance, and vehicle detection is performed according to the vehicle detection neural network model; the vehicle detection neural network model may be, for example, a YOLO neural network model and the like.

In another exemplary embodiment, a background image in the absence of a vehicle may be established in advance. The background image may be updated in a preset period to fit the actual situation and reduce errors. Multiple frames of images without vehicles may be captured and averaged as a background image. An image is binarized, and whether there is a vehicle in a current region is determined according to the background image; if there is a vehicle, a target vehicle is obtained by the difference between the current frame and the background image.

In act 303, when a vehicle is detected in the image, a vehicle tracking ID for the detected vehicle is created and the vehicle is tracked in subsequent images; vehicle detection boxes of successive S frames of images are recorded, where S is an integer greater than 1.

In an exemplary implementation, S is, for example, 5 to 10.

In act 304, for images of each two adjacent frames in the S frames, which are called a first adjacent frame and a second adjacent frame, whether a ratio of an overlapping area of vehicle detection boxes of the same vehicle (the same vehicle tracking ID) in the first and second adjacent frames to an area of a vehicle detection box of the vehicle in the first or second adjacent frame is greater than or equal to a preset ratio threshold, and step 305 will be executed when the area ratio is greater than or equal to the preset ratio threshold; when the area ratio is less than the preset ratio threshold, act 301 will be executed, where 0< the preset ratio threshold<1;

In act 305, a vehicle model of the detected vehicle is identified.

In an exemplary embodiment, the license plate of the detected vehicle is also identified to obtain the license plate number of the vehicle. The association between the license plate number and the terminal equipment may be configured in advance. Subsequently, the terminal equipment associated with the vehicle may be determined according to the license plate number.

In an exemplary embodiment, a neural network model may be used for license plate identification.

In act 306, vehicle information is output.

The vehicle information may include at least one of the following: a vehicle tracking ID, a vehicle detection box, vehicle model information, and license plate information.

According to the scheme provided by the embodiment, the vehicle detection, tracking and identification may be achieved according to images.

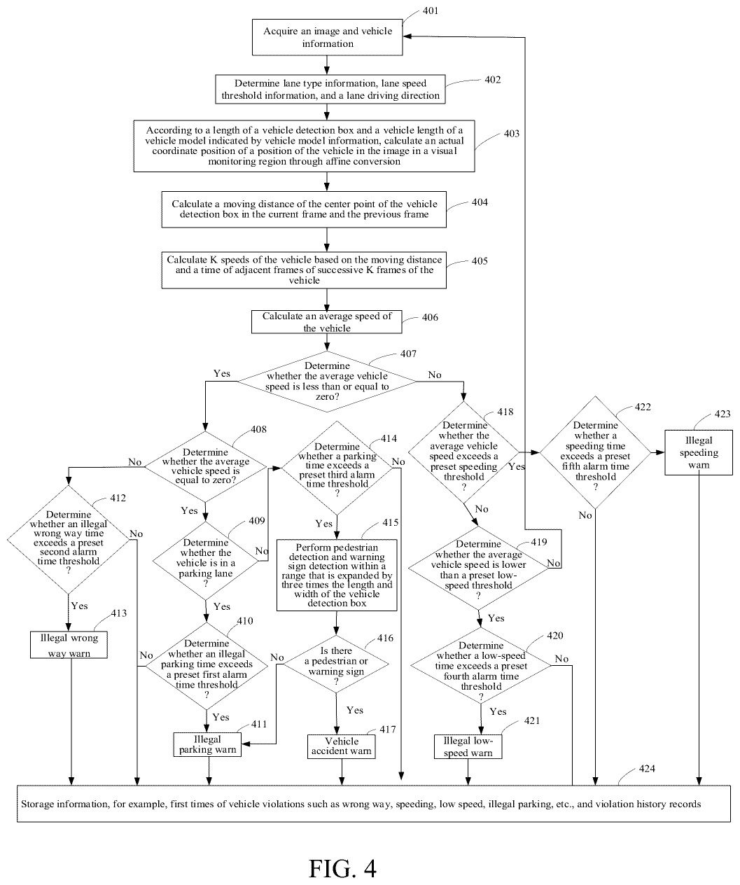

FIG. 4 is a flowchart of a vehicle violation detection method according to an exemplary embodiment. As shown in FIG. 4, the vehicle violation detection method provided by this embodiment includes the following acts.

In act 401, an image and vehicle information are acquired.

The vehicle information may include a vehicle tracking ID, a vehicle detection box, license plate information and vehicle model information.

In act 402, lane type information, lane speed threshold information, and a lane driving direction are determined.

In an exemplary embodiment, the lane type information may include, but is not limited to, at least one of the following: a fast lane, a low-speed lane, an emergency lane, and a non-motorized lane.

The lane speed threshold information indicates speed threshold information of the lane, for example, may include a speeding threshold and a low-speed threshold, or may include a threshold range from a low-speed threshold to a speeding threshold, wherein the speeding threshold is greater than the low-speed threshold. When the speed of the vehicle is less than the low-speed threshold of a lane where the vehicle is located or greater than the speeding threshold of a lane where the vehicle is located, the vehicle violates the traffic rules.

The driving direction of the lane is a prescribed driving direction of the lane.

The lane type information, lane speed threshold information, and lane driving direction may be pre-configured by the system or configured by a user.

In act 403, according to a length of the vehicle detection box and a vehicle length of the vehicle model indicated by the vehicle model information, an actual coordinate position of the vehicle in a visual monitoring region is determined through affine conversion.

The length of the vehicle (from front to rear) of each vehicle model may be stored in advance, for example, a length of a family car, a length of a truck, and so on.

In act 404, a moving distance of a center point of the vehicle detection box in the current frame and the previous frame is determined.

That is, a first actual coordinate position of a center point of a vehicle detection box of a current frame in a visual monitoring region is determined, and a second actual coordinate position of the center point of the vehicle detection box of a previous frame in the visual monitoring region is determined. A distance between the first actual coordinate position and the second actual coordinate position of the same vehicle is the moving distance of the vehicle.

The driving direction of the vehicle in the time from the previous frame to the current frame is also determined, and when the driving direction of the vehicle is consistent with the driving direction of the lane, the moving distance is a positive value; when the driving direction of the vehicle is opposite to the driving direction of the lane, the moving distance is a negative value. A determination mode is as follows: when a direction from the center point of the vehicle detection box of the previous frame to the center point of the vehicle detection box of the current frame is consistent with the driving direction of the lane, that is, when the direction from the second actual coordinate position to the first actual coordinate position is consistent with the driving direction of the lane, the driving direction of the vehicle is consistent with the driving direction of the lane; when the direction from the center point of the vehicle detection box of the previous frame to the center point of the vehicle detection box of the current frame is opposite to the driving direction of the lane, that is, when the direction from the second actual coordinate position to the first actual coordinate position is opposite to the driving direction of the lane, the driving direction of the vehicle is opposite to the driving direction of the lane.

In act 405, for each of the K successive frames, a moving distance of the center point of the vehicle detection box between the current frame and the previous frame and the time interval between the current frame and the previous frame are acquired to obtain a speed of the vehicle; a total of K speeds V₁ to V_{K} of the vehicle are obtained, where K is greater than or equal to 1.

Taking K successive frames as the second to sixth frames as an example, the time interval between frames is t0.

Then, for the second frame, a moving distance S1 of the center point of the vehicle detection box between the second frame and the first frame is calculated; a speed V₁=S1/t0 of the vehicle is obtained according to S1 and to.

For the third frame, a moving distance S2 of the center point of the vehicle detection box between the third frame and the second frame is calculated; a speed V₂=S2/t0 of the vehicle is obtained according to S2 and to.

For the fourth frame, a moving distance S3 of the center point of the vehicle detection box between the fourth frame and the third frame is calculated; a speed V₃=S3/t0 of the vehicle is obtained according to S3 and to.

For the fifth frame, a moving distance S4 of the center point of the vehicle detection box between the fifth frame and the fourth frame is calculated; a speed V₄=S4/t0 of the vehicle is obtained according to S4 and t.

For the sixth frame, a moving distance S5 of the center point of the vehicle detection box between the sixth frame and the fifth frame is calculated; a speed V₅=S5/t0 of the vehicle is obtained according to S5 and to.

In an exemplary embodiment, the K is, for example, 2 to 10.

In act 406, an average vehicle speed V is determined according to the K speeds; that is, V=(V₁+ . . . +V_{K})/K. Taking the foregoing K=5 as an example, V=(V₁+V₂+V₃+V₄+V₅)/5.

In act 407, whether the average vehicle speed V is less than or equal to 0 is determined; when the average vehicle speed V is less than or equal to 0, act 408 will be executed, and when the average vehicle speed V is greater than 0, act 418 will be executed.

In act 408, whether the average vehicle speed V is 0 is determined, and when the average vehicle speed V is 0, act 409 will be executed; when the average vehicle speed V is not 0, that is, V is less than 0, act 412 will be executed.

In act 409, whether the vehicle is in an illegal parking lane is determined; when the vehicle is in an illegal parking lane, act 410 will be executed, and when the vehicle is not in an illegal parking lane, for example, the vehicle is in an emergency lane, act 414 will be executed.

Illegal parking lanes are lanes that cannot be parked, which usually are other lanes outside the emergency lanes.

In act 410, whether a parking time of the vehicle in the illegal parking lane is greater than a preset first alarm time threshold is determined, act 411 will be executed when the parking time of the vehicle in the illegal parking lane is greater than the preset first alarm time threshold, and act 424 will be executed when the parking time of the vehicle in the illegal parking lane is less than or equal to the preset first alarm time threshold.

In act 411, the illegal parking of the vehicle is determined, the illegal parking alarm operation will be executed, the vehicle illegal parking alarm information may be sent to the terminal display device, and the vehicle illegal parking alarm information may be sent to the vehicle illegal management party (such as the management system of the vehicle management offices, etc.), and act 424 will be executed.

In act 412, in this case, the vehicle speed is less than 0 and is in a wrong way state, that is, the driving direction of the vehicle is inconsistent with the driving direction of the lane where the vehicle is located, whether the time for the vehicle to drive on wrong way exceeds the preset second alarm time threshold is determined, and act 413 will be executed when the time for the vehicle to drive on wrong way is greater than the preset second alarm time threshold; and act 424 will be executed when the time for the vehicle to drive on wrong way is less than or equal to the preset second alarm time threshold.

In act 413, the illegal wrong way of the vehicle is determined, the illegal wrong way alarm operation will be executed, the vehicle illegal wrong way alarm information may be sent to the terminal display device, and the vehicle illegal wrong way alarm information may be sent to the vehicle illegal management party (such as the management system of the vehicle management offices, etc.), and act 424 may be executed.

In act 414, whether the parking time of the vehicle is greater than the preset third alarm time threshold is determined, act 415 will be executed when the parking time of the vehicle is greater than the preset third alarm time threshold; and act 424 will be executed when the parking time of the vehicle is less than or equal to the preset third alarm time threshold.

In act 415, pedestrian detection and preset warning sign detection are performed within a preset periphery range of the vehicle detection box of the vehicle, and act 416 will be executed.

Pedestrian detection and preset warning sign detection may be performed based on the neural network model obtained from deep learning.

In act 416, whether a pedestrian or a preset warning sign is detected is determined, and when the pedestrian or the preset warning sign is detected, act 417 will be executed; when a pedestrian or a preset warning sign is not detected, act 411 will be executed.

In act 417, the vehicle accident is determined, the vehicle accident alarm operation will be executed, the vehicle accident alarm information may be sent to the terminal display device, and the vehicle accident alarm information may be sent to the vehicle violation management party (such as the management system of vehicle management offices, etc.), and act 424 will be executed.

In act 418, whether the average speed of the vehicle is greater than the speeding threshold is determined, and when the average speed of the vehicle is greater than the speeding threshold, act 422 will be executed; when the average speed of the vehicle is less than or equal to the speeding threshold, act 419 will be executed.

In act 419, whether the average speed of the vehicle is less than a low-speed threshold is determined, and when the average speed of the vehicle is less than the low-speed threshold, act 420 will be executed; when the average speed of the vehicle is greater than or equal to the low-speed threshold, act 401 will be executed.

In act 420, whether a time for the average speed of the vehicle less than the low-speed threshold is greater than a preset fourth alarm time threshold is determined, and act 421 will be executed when a time for the average speed of the vehicle less than the low-speed threshold is greater than the preset fourth alarm time threshold; and act 424 will be executed when the average speed of the vehicle is less than or equal to the low-speed threshold time is less than the preset fourth warning time threshold.

In act 421, the illegal low-speed of the vehicle is determined, the illegal low-speed alarm operation will be executed, the illegal low-speed alarm information may be sent to the terminal display device, and the illegal low-speed alarm information may be sent to the vehicle violation management party (such as the management system of vehicle management offices, etc.), and act 424 will be executed.

In act 422, whether a time for the average speed of the vehicle greater than the speeding threshold is greater than a preset fifth alarm time threshold is determined, act 423 will be executed when the average speed of the vehicle is greater than the speeding threshold is greater than the preset fifth alarm time threshold, and act 424 will be executed when a time for the average speed of the vehicle greater than the speeding threshold is less than or equal to the preset fifth alarm time threshold.

In act 423, the illegal speeding of the vehicle is determined, the illegal speeding alarm operation will be executed, the illegal speeding alarm information may be sent to the terminal display device, and the illegal speeding alarm information may be sent to the vehicle violation management party (such as the management system of vehicle management offices, etc.), and act 424 will be executed.

In act 424, violation information is stored, which includes but is not limited to the following: recording a starting time of violation such as wrong way, speeding, low-speed or illegal parking of the vehicle, a behavior that has been determined as violation, etc.

Taking vehicle wrong way as an example, when a time for driving on to drive on wrong way is detected for the first time to be less than or equal to a preset second alarm time threshold, a vehicle wrong way starting time is recorded. The first time here means that the wrong way is detected for the first time in a continuous wrong way process. When there are multiple wrong ways (a continuous wrong way process from beginning to end as one wrong way), a starting time of each wrong way is recorded. Speeding, low-speed, illegal parking, etc. are similar and will not be explained again.

In another exemplary implementation, the moving distance may be a non-negative value, when the speed information of the vehicle is not 0, whether the driving direction of the vehicle is consistent with the driving direction of the lane where the vehicle is located may be determined before the violation determination, and when the driving direction of the vehicle is inconsistent with the driving direction of the lane where the vehicle is located, whether the vehicle has wrong way violation is determined; when the driving direction of the vehicle is consistent with the driving direction of the lane where the vehicle is located, whether there is an illegal speeding or an illegal low-speed is determined.

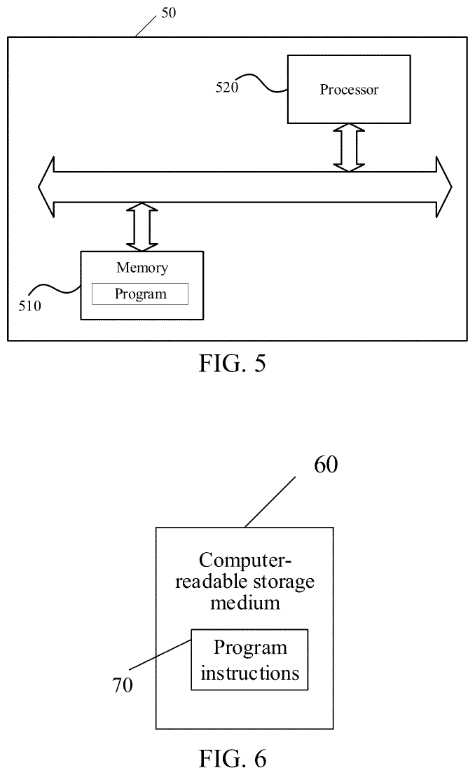

As shown in FIG. 5, an embodiment of the present disclosure provides a vehicle violation detection device 50, which includes a processor 520 and a memory 510 storing a computer program executable on the processor, wherein the processor 520 implements the acts of the vehicle violation detection method according to any of the above embodiments when executing the program.

As shown in FIG. 6, an embodiment of the present disclosure provides a computer-readable storage medium 60 which stores program instructions 70. When the program instructions 70 are executed, the vehicle violation detection method described in any of the above embodiments may be implemented.

Those of ordinary skills in the art may understand that all or some of acts in the methods disclosed above, systems, functional modules or units in devices may be implemented as software, firmware, hardware, and an appropriate combination thereof. In a hardware implementation, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer-readable medium, and the computer-readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer-readable instruction, a data structure, a program module, or other data). The computer storage medium includes, but is not limited to, a Random Access Memory (RAM), a Read-Only Memory (ROM), an Electrically Erasable Programmable ROM (EEPROM), a flash memory or other memory technologies, a Compact Disc Read-Only Memory (CD-ROM), a Digital Video Disk (DVD) or other optical discs, a cassette, a magnetic tape, a disk memory or other magnetic storage devices, or any other medium configurable to store expected information and accessible by a computer. In addition, it is known to those of ordinary skills in the art that the communication medium usually includes a computer-readable instruction, a data structure, a program module, or other data in a modulated data signal of, such as, a carrier or another transmission mechanism, and may include any information delivery medium.

1. A vehicle violation detection method, comprising:
acquiring a plurality of frames of images, carrying out vehicle detection and tracking according to the plurality of frames of images, and generating vehicle information of a detected vehicle, wherein the vehicle information comprises a vehicle detection box and vehicle model information; the vehicle model information corresponds to a vehicle physical size;
determining a correspondence relationship between image coordinates in the images and absolute spatial coordinates according to a size of a vehicle detection box of the vehicle and a vehicle physical size corresponding to vehicle model information of the vehicle, and determining speed information of the vehicle according to the correspondence relationship; and
carrying out violation determination of the vehicle according to the speed information of the vehicle.

2. The vehicle violation detection method according to claim 1, wherein acquiring the plurality of frames of images, and carrying out vehicle detection and tracking according to the plurality of frames of images comprises:
acquiring one frame of image, under a condition that a vehicle is detected in the frame of image, tracking the vehicle in at least one subsequent frame of image, recording vehicle detection boxes of successive S frames of images of the vehicle, and under a condition that a ratio of an overlapping area of vehicle detection boxes of the vehicle in adjacent frames of images of the S frames of image to an area of any vehicle detection box of the vehicle in the adjacent frames of images is greater than or equal to a preset ratio threshold, identifying vehicle model information of the vehicle, wherein, 0< the preset ratio threshold<1, and S is an integer greater than 1.

3. The vehicle violation detection method according to claim 1, wherein 0.35≤ a preset ratio threshold≤0.75.

4. The vehicle violation detection method according to claim 1, wherein determining the speed information of the vehicle according to the correspondence relationship comprises:
determining absolute spatial coordinates corresponding to same positions in vehicle detection boxes of two frames of images according to the correspondence relationship, determining a displacement distance between the same positions in the vehicle detection boxes of the two frames of images according to the absolute spatial coordinates corresponding to the same positions in the vehicle detection boxes of the two frames of images, and determining a first speed of the vehicle according to the displacement distance and a time interval between the two frames of images;
taking the first speed as the speed information of the vehicle; or, acquiring a plurality of first speeds according to images of different frames, and taking an average value of the plurality of first speeds as the speed information of the vehicle.

5. The vehicle violation detection method according to claim 4, wherein the two frames of images are two adjacent frames of images;
acquiring the plurality of first speeds according to images of different frames comprises:
acquiring the plurality of first speeds according to images of every two adjacent frames in a successive plurality of frames of images.

6. The vehicle violation detection method according to claim 1, wherein
carrying out the violation determination of the vehicle according to the speed information of the vehicle comprises at least one of the following:
determining illegal parking of the vehicle under a condition that the speed information of the vehicle is zero, the vehicle is located in an illegal parking lane, and a time for the vehicle to stay in the illegal parking lane is greater than a preset first alarm time threshold;
determining vehicle accident under a condition that the speed information of the vehicle is zero, the vehicle is located in a non-illegal parking lane, a time for the vehicle to stay in the non-illegal parking lane is longer than a preset third alarm time threshold, and a pedestrian or a preset warning sign is detected in a preset periphery range of the vehicle detection box;
determining illegal parking of the vehicle under a condition that the speed information of the vehicle is zero, the vehicle is located in a non-illegal parking lane, a time for the vehicle to stay in the non-illegal parking lane is longer than the preset third alarm time threshold, and a pedestrian or a preset warning sign is not detected in the preset periphery range of the vehicle detection box;
determining illegal wrong way of the vehicle under a condition that the speed information of the vehicle is non-zero, a driving direction of the vehicle is inconsistent with a driving direction of a lane where the vehicle is located, and a time for the vehicle to drive on wrong way is longer than a preset second alarm time threshold;
determining illegal low-speed of the vehicle under a condition that the speed information of the vehicle is less than a preset low-speed threshold, a driving direction of the vehicle is consistent with a driving direction of a lane where the vehicle is located, and a time for the speed information of the vehicle less than the preset low-speed threshold is longer than a preset fourth alarm time; and
determining illegal speeding of the vehicle under a condition that the speed information of the vehicle is greater than a preset speeding threshold, a driving direction of the vehicle is consistent with a driving direction of a lane where the vehicle is located, and a time for the speed information of the vehicle greater than the preset speeding threshold is greater than a preset fifth alarm time.

7. The vehicle violation detection method according to claim 1, wherein the vehicle information further comprises: license plate information;
the method further comprises: determining a terminal equipment associated with the vehicle according to the license plate information; and,
after the violation determination of the vehicle is carried out according to the speed information of the vehicle and that the vehicle has violation is determined, sending violation behavior information of the vehicle to the terminal equipment associated with the vehicle.

8. The vehicle violation detection method according to claim 7, wherein the method further comprises:
storing vehicle information, and violation behavior information generated after the violation determination of the vehicle is carried out, performing statistics based on the vehicle information and the violation behavior information to generate statistical information, and sending statistical information related to the vehicle to the terminal equipment associated with the vehicle, wherein the statistical information related to the vehicle comprises at least one of the following: statistical information obtained by performing statistics based on violation behavior information of the vehicle, and statistical information obtained by performing statistics based on violation behavior information of a vehicle model to which the vehicle belongs.

9. The vehicle violation detection method according to claim 8, wherein the violation behavior information comprises a road section where a violation behavior occurred, and the statistical information comprises at least one of the following: frequencies of different violation behaviors of a same vehicle, frequencies of different violation behaviors of a same vehicle model, and frequencies of violation behaviors of a same vehicle model on different road sections.

10. A vehicle violation detection device, comprising a processor and a memory storing a computer program runnable on the processor, wherein the processor executes the program to implement the acts of the vehicle violation detection method according to claim 1.

11. A computer-readable nonvolatile storage medium storing program instructions, under a condition that the program instructions are executed, the program instructions can perform the vehicle violation detection method according to claim 1.

12. A vehicle violation detection system, comprising: a video acquiring device, and the vehicle violation detection device according to claim 10, wherein the video acquiring device is configured to acquire an image of a preset monitoring region and send the image to the vehicle violation detection device.

13. A vehicle violation detection device, comprising: a processor, wherein:
the processor is configured to acquire a plurality of frames of images, carry out vehicle detection and tracking according to the plurality of frames of images, and generate vehicle information of a detected vehicle, wherein the vehicle information comprises a vehicle detection box and vehicle model information, and the vehicle model information corresponds to a vehicle physical size; and output the vehicle information to the violation behavior detection module;
the processor is further configured to determine a correspondence relationship between image coordinates in the images and absolute spatial coordinates according to a size of a vehicle detection box of the vehicle and a vehicle physical size corresponding to vehicle model information of the vehicle, and determine speed information of the vehicle according to the correspondence relationship; and carry out violation determination of the vehicle according to the speed information of the vehicle.

14. The vehicle violation detection method according to claim 1, wherein before the violation determination of the vehicle is carried out based on the speed information of the vehicle, the method further comprises: determining lane type information, lane speed threshold information, and lane driving direction.

15. The vehicle violation detection method according to claim 6, wherein an area of the preset periphery range and an area of the vehicle detection box are 2 to 4 times the area of the vehicle detection box.

16. The vehicle violation detection method according to claim 4, wherein the two frames of images are two non-adjacent frames of images.

17. The vehicle violation detection method according to claim 1, wherein the vehicle information further comprises: an average driving speed of a vehicle, a maximum driving speed of a vehicle, a minimum driving speed of a vehicle, a vehicle trajectory.

18. The vehicle violation detection method according to claim 1, further comprising: performing license plate identification according to a license plate identification neural network model.

19. The vehicle violation detection method according to claim 1, further comprising: performing vehicle model identification according to a vehicle model identification neural network model.

20. The vehicle violation detection method according to claim 1, further comprising: periodically performing statistics of violation behaviors at a preset period.
